(19) United States
(12) Patent Application Publication
(10) Pub. No.: US 2019/0186693 A1
(43) Pub. Date: Jun. 20, 2019

(54) PRESSURIZED GAS CONTAINER

(71) Applicant: STRAUSS WATER LTD, Petach Tikva (IL)

(72) Inventors: Haim WILDER, Ra'anana (IL); Eyal KRYSTAL, Kfar Saba (IL); Gil YARDENI, Or-Yehuda (IL)

(73) Assignee: STRAUSS WATER LTD, Petach Tikva (IL)

(21) Appl. No.: 16/099,717

(22) PCT Filed: May 8, 2017
(86) PCT No.: PCT/IL2017/050502

§ 371 Date: Nov. 8, 2018

Related U.S. Application Data
(60) Provisional application No. 62/333,236, filed on May 8, 2016.

(51) Int. Cl. F17C 1/14; F17C 5/06; F17C 1/02; F17C 1/16

(52) U.S. Cl. CPC F17C 1/14; F17C 5/06; F17C 1/02; F17C 1/16; F17C 2203/0646; F17C 2203/066; F17C 2203/0648; F17C 2221/013; F17C 2203/011; F17C 2209/2109; F17C 2209/232; F17C 2201/0109; F17C 2203/0619; F17C 2205/0302

(57) ABSTRACT

Provided a multi-layered pressurized gas container, for example one containing carbon dioxide for use in a device or system for the preparation of a carbonated drink, and processes for its manufacture.

### TECHNOLOGICAL FIELD

The present disclosure concerns a pressurized gas container, for example one containing carbon dioxide for use in a device or system for the preparation of a carbonated drink.

### BACKGROUND ART

References considered to be relevant as background to the presently disclosed subject matter are listed below:
GB 2,176,586
U.S. Pat. No. 3,587,926
U.S. Pat. No. 3,684,132
WO 2015/118525
WO 2016/135715

Acknowledgement of the above references herein is not to be inferred as meaning that these are in any way relevant to the patentability of the presently disclosed subject matter.

### BACKGROUND

Pressurized gas containers are typically used in systems or appliances that require in-feed of pressurized gas. An appliance for the preparation of a carbonated beverage is one such example. Most pressurized gas containers are designed for multiple use, i.e. the container's volume and/or gas pressure are sufficient for several gas-feed doses. This typically requires the container to be associated with a mechanism allowing connecting and disconnecting gas flow between the container and the appliance or system. Often, the container itself is equipped with a gas-flow control mechanism, such as a valve or a re-sealable membrane, to permit a user to disconnect the container from the appliance or the system while preventing gas leakage from the container.

In addition, the containers are often designed for multiple use cycles, i.e., once the container is emptied, it is often shipped back to the provider for cleaning and re-filling. Such a container is typically designed to meet strict safety requirements, such as relatively thick wall thickness and robust re-sealable opening in order to minimize accidental rupturing of either the seal or the container. This, however, results in high production costs and complex logistics. Moreover, many such containers are not returned after utilization to the supplier for re-filling, resulting in relatively high sunk-costs.

Disposable containers (namely, containers intended for a single use) were disclosed in WO 2015/118525 and WO 2016/135715.

### GENERAL DESCRIPTION

Provided by this disclosure is a novel pressurized gas container intended for a single use, hence being a disposable container. The pressurized gas container of this disclosure is uniquely designed to have a multi-layered body with a thin metal layer overlaid by a molded layer. In this unique structure, the metal layer that surrounds and defines the pressurized gas enclosure may be dramatically thinner than the predominantly metal walls of pressurized containers intended for multiple use. The molded layer serves the dual primary purpose of (i) assisting in the ability of the relatively thin metal layer to withstand high pressure; and (ii) supporting the metal layer against pressure induced deformation.

The disposable container of this disclosure comprises a plug unit fitted with a generally planar barrier that seals the enclosure. The barrier has portions of reduced thickness that define relatively weak spots which, upon exertion of force in a direction normal to the barrier, can tear open thereby facilitating controlled rupturing of the barrier element.

It is to be noted that while the walls are typically two layered, i.e. a metal layer and the molded layer, by some embodiments the walls may be formed with additional layers, such as an innermost liner, e.g. made of a plastic material; and an outermost layer of protective coating, paint, decorative coating, label, etc.

The metal layer is typically, but not exclusively, aluminum or aluminum alloy. The molded layer is made of a moldable material, which may be a material having thermoplastic properties, such as polyethylene, polypropylene, polyvinyl chloride (PVC), polyurethane, polymethyl methacrylate (PMMA), polyethylene terephthalate (PTE), acrylonitrile butadiene styrene (ABS), blends and co-polymers of different polymers, as well as thermoplastic material of the kind disclosed in WO 2012/007949, etc.

Other features of the container of this disclosure will be elucidated in the description below. It is to be noted that this disclosure also provides process for the manufacture of a container and for filling it with pressurized gas, a container blank and a plug unit that may be combined to form a container of this disclosure, a process for the manufacture of such container blank as well as an adapter unit to be described below.

The pressurized gas container, typically and axial symmetric container, comprises a container body that defines the pressurized gas enclosure with an integral neck that extends from the shoulders of the container to an end portion. The end portion is configured for association with a gas port of a device, appliance or system, where the gas is to be utilized. The end portion is also fitted with a plug unit. The container body has a multi-layer wall that comprises a metal layer overlaid by a molded layer. The plug unit has an axial bore dimensioned to accommodate a gas-channeling shaft of said gas port. The barrier element is generally planar and is deployed in an inner end of the bore forming a gas-tight barrier between the bore and the enclosure. The barrier element has one or more first portions of reduced thickness to that of other portions of the barrier element such that, upon exertion of force on the barrier, the one or more first portions would rupture the barrier at said portions to thereby permit gas outflow from the enclosure. The plug unit has also one or more sealing elements, e.g. O-rings, disposed in the bore and being distinct from said barrier element and configured for forming a gas-tight association with said shaft.

During coupling to a gas port, the shaft of the gas port, that is axially oriented, penetrates the bore and in the process exerts a force on the barrier element causing it to rupture at said portions, which are weak spots in the barrier (intended for that purpose). The sealing element, typically an O-ring (as noted above) prevents uncontrolled gas release and ensures that the gas release will be in a controlled manner through gas ducts formed within said shaft that are linked and in flow-communication with a gas receiving system within the device, appliance or system.

In the following, the term device will be used for convenience to refer to both appliance, device or system that is provided with a gas port for associating with the container for receiving and utilizing the pressurized gas.

The gas container may, by one embodiment, be a pressurized carbon dioxide container, for association with a device for the preparation and dispensing of a carbonated beverage.

The barrier element is typically a metal sheet although, by some embodiments, it may also be made of materials other than metal, particularly plastic. A metal barrier element, however, has the advantage of long-term durability and in its ability to withstand the pressure differential across the barrier. A plastic barrier element, for example, may show fatigue after long-term storage under the pressure differential across the barrier but may be suitable, in particular, for use in applications intended for short term storage.

By one embodiment, the first portions of reduced thickness are intersecting grooves, typically intersecting at the bore's axis. The plug unit may, by some embodiments, be a standalone element fitted directly into the end portion of the container neck, although it may at times be fitted within an adapter coupled to the container's neck. Such adapter is typically configured to have a device-coupling portion and a container-coupling portion that are integral with one another. The device-coupling portion comprises upright, axially extending first walls with outer generally cylindrical face intended to serve for coupling (e.g. threaded coupling or bayonet coupling) with said gas port. The first walls are formed around and define between them the first lumen portion that also defines a plug seat for accommodating the plug. The container-coupling portion comprises downright and axially extending second walls that are tightly associated with and envelope the upper portion of the neck's metal layer. Thus, the second walls are typically embedded in or associated with the molded layer. The second walls typically have an external surface relief (e.g. annular abutments or rings) to permit tight association with the molded layer, i.e. by increasing the contact area between the molded layer and the external surface of the second portion, thus increasing mechanical interlocking with the molded layer.

In order to ensure a gas-tight association between the second walls and external surface of the metal layer (to avoid gas leakage in-between the two), the second walls of the adapter are typically provided with an internal annular groove that accommodates an O-ring to provide for a gas-tight association with the metal layer.

By one embodiment, the adapter comprises radial shoulders, formed between its two portions. These radial shoulders are typically intended for association with an external fastening ring, that may be made of metal or plastic, that is pressure-fitted onto the container's neck. Once fitted onto the neck portion of the container, the fastening ring's top portion tightly pressed against the adapter's shoulders to provide for tight association therewith.

By an exemplary embodiment, the container may comprise one or both of a bottom reinforcing element and a top reinforcing element coupled to or embedded in the molded layer. The bottom reinforcing element may define a base of the container. The top reinforcing element is one typically formed so as to fit over the shoulders of the internal metal layer.

The fact that the container is intended for a single use permits it to have a relatively thin metal layer, e.g. having a thickness of about 0.5 to 4 mm. This is a dramatically reduced thickness of the metal walls as compared to a standard pressurized gas container, the average thickness being 55%, 50%, 45%, 40%, 35%, 30%, 25% and at times even lower than the average thickness of the walls of a pressurized gas container body intended for multiple use. This leads to considerable saving in weight and costs. The container's overall wall thickness is typically in the range of about 3 to 8, with the ratio between the thickness of the molded layer to that of the metal layer being in the range of about 1:1 to 20:1, about 1:1 to 15:1, or even 1:1 to 10:1.

Also provided by this disclosure is a multipack with a plurality of containers which comprises: (i) a holder rack (ii) a carrying element typically integral with the rack; and (iii) a plurality of gas containers as disclosed herein. The holder rack may be configured as a case, box, etc. with a plurality of slots for holding the containers, and may be made of cardboard, plastic or any other suitable material. The overall configuration of the multipack of this disclosure is typically that similar to a multipack of bottles or cans. The rack may also be configured for holding the containers in a hanging fashion.

Provided by this disclosure is also a process for the manufacture of the gas container; as well as a process for the manufacture of a container blank for subsequent introduction of pressurized gas, and fitting a plug unit to seal the container.

The following process will be described as including molding, introducing pressurized gas and fitting a plug unit (all of which are described below); although it should be understood that the first step of molding to prepare a container blank is an independent aspect of this disclosure.

The first step of the process comprises molding a molded layer onto an external surface of a metal blank of the container to thereby obtain a container blank. The terms metal blank and container blank should not be confused, the former referring to a metal blank onto which the molded layer is formed to eventually produce a container blank of this disclosure. The metal blank has a form that defines the eventual form of the container blank and it comprises a body that defines an enclosure, a metal blank neck that extends axially from the shoulders of the metal blank body and being integral therewith. Following molding, a multi-layer container blank is obtained that includes a multi-layer container body with a neck portion configured for association with a gas port of the device.

The molding of the molded layer may be through cast molding or injection molding.

This container blank is then filled with pressurized gas and eventually fitted with a plug unit of the kind described above to seal the container's opening. While this is one possible sequence of steps in the preparation of the container by this disclosure, one can appreciate that a different sequence may also be possible, such as for example filling pressurized gas into a metal blank, sealing the metal blank's opening with a plug unit and only thereafter molding the molded layer onto the external surface of the metal. While the former sequence is the more typical one, the disclosure should not be construed as being limited to this sequence only.

Optionally, prior to said molding the enclosure may be filled with a fluid, such as water or pressurized gas, to prevent distortion or collapsing of the walls of metal blank during molding. Before filling the container with pressurized gas the fluid has to be emptied and the enclosure may be cleaned and/or dried.

For convenience the disclosure will be described below with reference to the more typical manufacturing sequence.

As noted above, gas pressure is introduced into the enclosure of the container blank and a plug unit of the kind specified herein is fitted into the neck to seal the opening in a gas-tight manner. A typical example of this process is for the preparation of a gas container for use in a device intended for preparation of a carbonated beverage.

The step of fitting typically comprises seating the plug unit within a seat, in a first lumen portion of an adapter, of the kind described above. In a typical manufacture sequence, the adapter is fitted onto the neck of the metal blank prior to molding the molded layer.

In order to ensure tight fitting of the plug unit within the seat, the top lips of the adapter's first portion are deformed to fix the plug unit in position. A sealing element, typically one or more O-rings positioned within annular grooves formed in the extemal surface of the plug unit, provide for a gas-tight seal between the plug and the internal face of the first walls of the adapter.

The process may also comprise, after molding, a step of pressure-fitting a fastening ring onto the container's neck and over the adapter's shoulders.

The manufacturing process may also include a step of fitting one or more of a bottom reinforcing element and a top reinforcing element at the bottom and onto the shoulders of the container blank, respectively, before molding.

The use of a fluid during the molding step of the process is an independent aspect of this disclosure. According to this aspect an enclosure of a metal blank, e.g. one having the general structure described above, is filled with a fluid, such as water or pressurized gas. A molded layer is then molded on the blank's extemal surface to thereby obtain a multi-layer container body and then emptying the fluid and optionally cleaning and/or drying the enclosure.

Another aspect of this disclosure includes a container blank, a plug unit and an adapter element.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a perspective view of a container of this disclosure with the molded layer made transparent to be able to view internal reinforcing elements embedded therein.

FIG. 2 is an exploded view of a container of FIG. 1 showing its elements.

FIGS. 3A and 3B are longitudinal cross-sections through the container of FIG. 1 and a container blank, respectively, along axis III-III in FIG. 2.

FIGS. 4A and 4B are, respectively, an enlarged view of the region marked IV in FIG. 3A, and shows an adapter of the container in FIG. 4B in isolation.

FIGS. 5A and 5B are, respectively, an isometric cross-sectional view and a top perspective view of a plug unit.

FIG. 6 is a schematic illustration of a manufacturing process of the pressurized gas container.

FIGS. 7A and 7B illustrate the molding equipment according to an exemplary embodiment of the molding process.

FIGS. 8 and 9 show two exemplary embodiments of a multilayer container of this disclosure where the molded layer is formed without reinforcing elements.

### DETAILED DESCRIPTION OF EMBODIMENTS

The invention will now be illustrated with a specific description of a container embodiment of this disclosure and the manner in which it is manufactured. This specific description is intended to provide further illustration and is not intended to be limiting in any way.

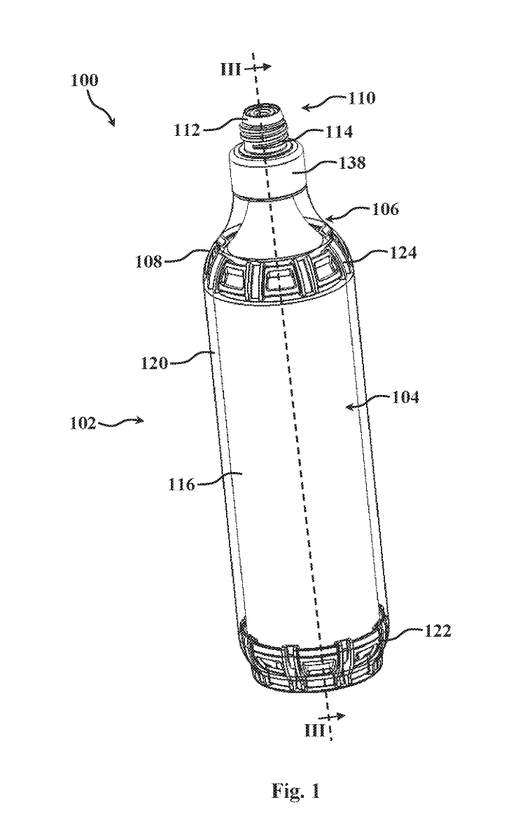

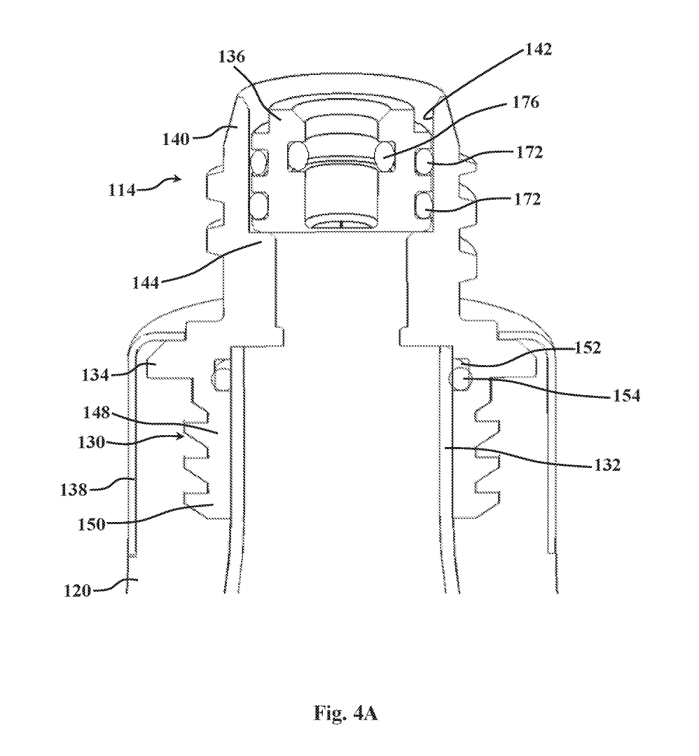

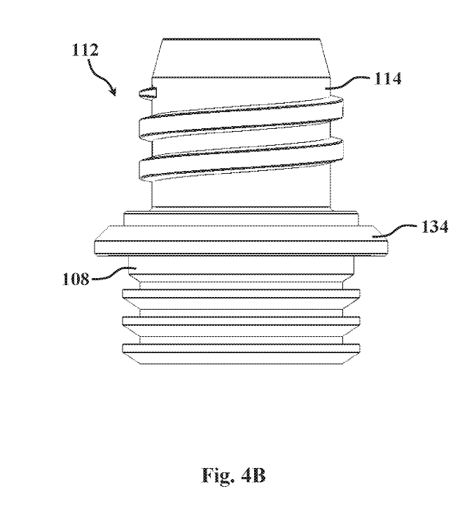

Container 100, shown in FIG. 1, has a container body 102 that is formed around and defines a pressurized gas enclosure 104. The container has a neck 106 extending from the container's shoulders 108 and integral with body 102. The end portion 110 of the neck is fitted with an adapter 112. The adapter, as can be seen in FIG. 1 (as well as FIG. 4B), has a device-coupling upper portion 114 with external threading for coupling to a gas port of a device in which the pressurized gas is to be received and utilized. Although such external threading are typically used, other types of coupling, e.g. bayonet coupling, are also possible.

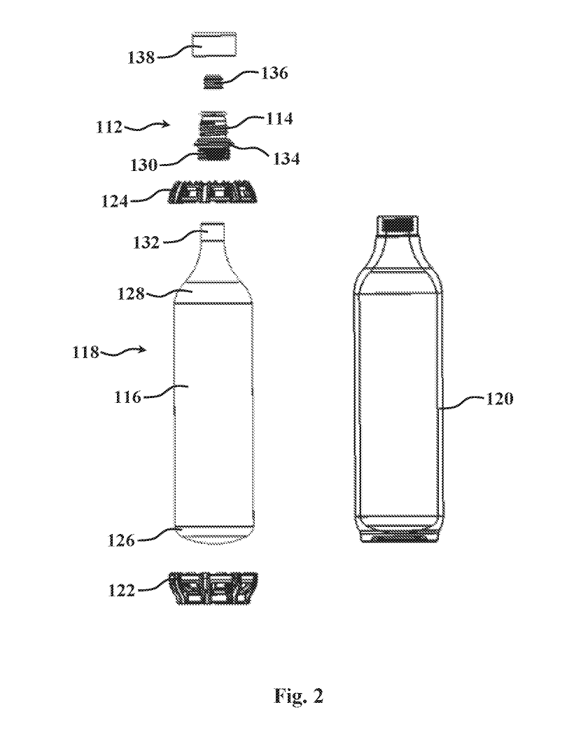

The container body has a multi-layered wall, which in the illustrated embodiment comprises two layer. This two-layer wall includes an internal metal layer 116 constituted by a metal container blank 118 (better seen in FIG. 2), which is overlaid by a molded layer 120 (also shown in isolation in FIG. 2). It should be noted that in distinction from the metal blank 118 which is independently formed (by metal molding, extrusion, blow molding, etc.), the molded layer is not an independently formed unit, as illustrated for ease of viewing in FIG. 2, but rather a layer molded on top of the metal blank 118 by injection molding, cast molding, etc.

Embedded in the molded layer are a bottom reinforcing element 122 and top reinforcing element 124. Both of these have a mesh or basket-like structure and are fitted at the bottom 126 and on top of shoulders 128, respectively, of metal blank 118, prior to molding the molded layer on top of the metal blank. Consequently, these reinforcing elements become embedded in the molded layer. It is to be noted that plastic material does not adhere well to metal and these two reinforcing elements serve, among others, to hold the entire molded layer and ensure its integrity; this may be of importance in the event that the metal layer slightly changes in dimension, e.g. as a result of the change in temperature. It is of note that only one of bottom and top reinforcing elements 122,124 may be used, or at times no reinforcing elements are used.

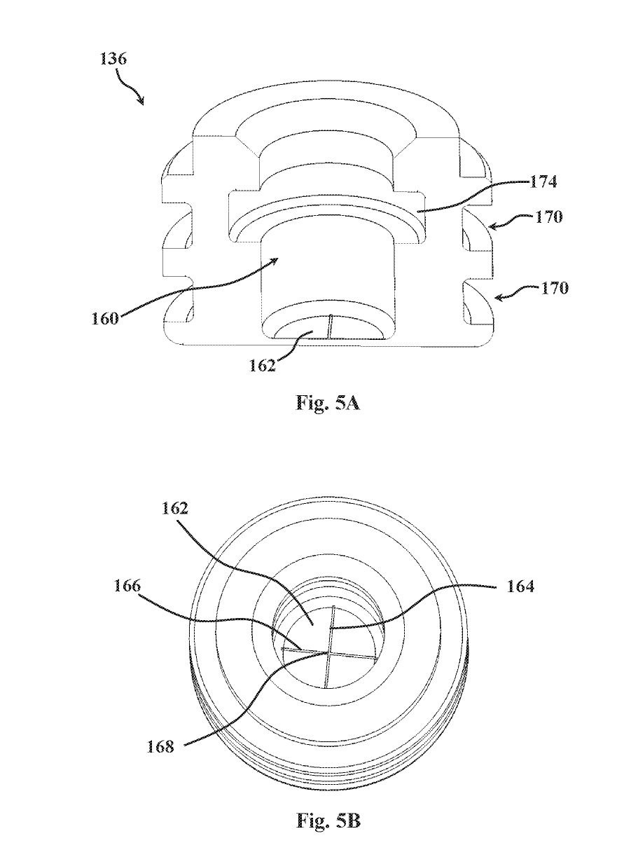

The adapter, as will also be further described below, has a container-coupling portion 130 fitted over the neck 132 of the metal blank 118. As a result of such fitting, portion 130 envelopes the upper neck portion 132 and becomes tightly associated therewith. Plug unit 136, which will also be further explained in more detail below (and can be seen in isolation in FIGS. 5A-5B), is fitted into adapter 112 in the manner to be described.

Another element of the container, shown in FIGS. 1 and 2, is fastening ring 138 which is externally fitted over the neck of the container and secures the adapter in position, among others, through association with adapter shoulders 134.

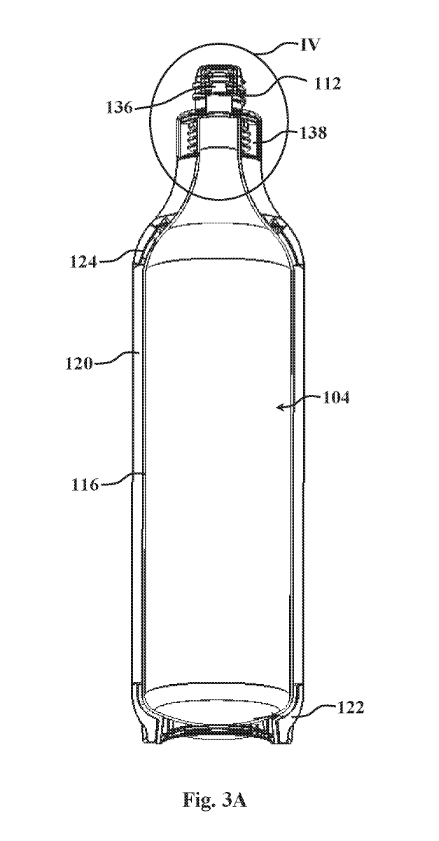

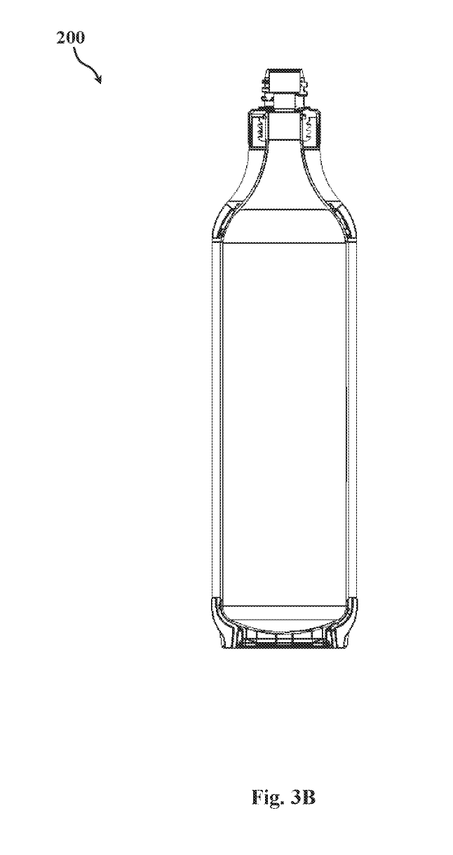

FIGS. 3A and 3B further illustrate the structure of the container 100 and of the container blank 200, respectively.

The structure of the adapter 112 can be seen in more detail in FIGS. 4A and 4B. The device-coupling portion of the adapter comprises upright, axially extending first walls 140 that are formed around the first lumen 142, in which a plug seat 144 is defined. The first walls 140, as already noted above, are externally threaded to permit coupling to a gas port of the device. The container-coupling portion 130 comprises downright, axially extending second walls 148 that, as can be seen and as noted above, are tightly associated with and envelope the upper portion of the metal neck portion 132. The second walls 148 have external surface relief 150, constituted in this case by a plurality of annular abutments, that are embedded within the molded layer 120, with the surface relief ensuring tight association with the molded layer. An internal annular groove 152 is formed within the second walls, accommodating the O-ring 154 which ensures gas-tight association with the external surface of the metal neck to avoid leakage of pressurized gas between the adapter and the metal neck after the barrier element has been ruptured.

Defined between the two portions of the adapter are radially extending adapter shoulders 134. As can also be seen in FIG. 4A, fastening ring 138 is fitted around the neck, with its upper portion pressing against adapter shoulders 134, holding the adapter tightly in position.

Fitted within lumen 142 and seated on seat 144 is a plug unit 136, shown in isolation in FIGS. 5A and 5B.

The plug unit 136 has an axial bore 160 dimensioned to accommodate a gas-channeling shaft of the gas port (the shaft is typically configured with ducts or openings to channel the pressurized gas into a receiving system within the device). Formed at the inner end of the bore (i.e. the end portion of the plug unit that faces the container's enclosure) is a generally planar barrier element 162. In this embodiment the barrier element is integrally formed with the plug unit; however in other embodiments the barrier element may be an independent element glued or welded to the bottom end of the plug, or may be an element which is forcibly held between the plug unit and the seat. A unique feature of the barrier element is that it has one or more portions of reduced thickness as compared to the thickness of other portions of the barrier element; in this embodiment, the portions of reduces thickness are constituted by two intersecting grooves 164, 166 that intersect at the barrier's center 168, being on the axis of the bore.

In this specific embodiment, the barrier element has a disc-like geometry, although by other embodiments the inner end of the bore may be differently formed to accommodate a barrier element of other shapes. When force is exerted in a direction normal to the barrier element, which in use such force is applied by the end of the gas-channeling shaft, the barrier element ruptures in a controlled manner in these portions of reduced thickness to permit gas outflow from the enclosure.

Formed at the outer face of the plug unit are two annular grooves 170 that, as can be seen in FIG. 4A, accommodate O-rings 172 to ensure gas-tight association between the plug unit and the inner face of lumen 142. Formed within bore 160 is an internal annular groove 174, accommodating an O-ring 176 for gas-tight association with the external face of the gas-channeling shaft (not shown) of the gas port.

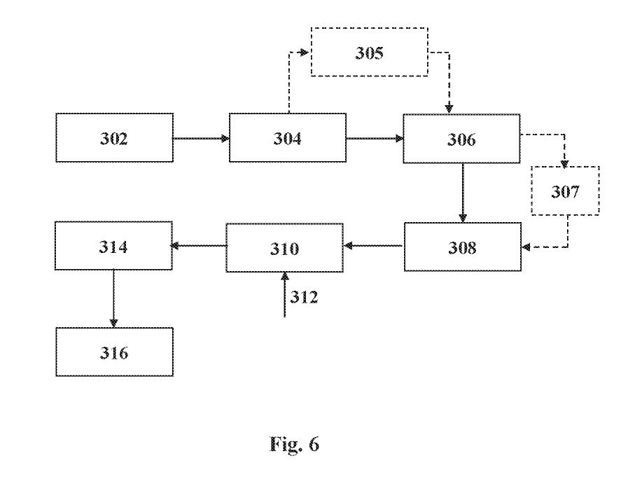

A process for the manufacture of a gas container is shown in FIG. 6. The process will be described as one continuous process, beginning with the manufacture of the container blank and ending with the filling of pressurized gas, e.g. carbon dioxide, and sealing the container with the plug to obtain a pressurized gas container. As noted above, the container blank as well as its manufacture are independent aspects of this disclosure and thus the first part of the disclosure ending with the container blank may be continued also as a process of this disclosure and the resulting blank has an embodiment of this disclosure.

In a first step 302 of the process, a metal blank 118 is provided and fitted with bottom and top reinforcing elements 122,124. In a subsequent step 304, the adapter 112 is fitted on the neck of the metal blank 118 and thereafter, at 306 the molded layer 120 is molded over the metal blank. Optionally, prior to step 306, another step 305 may be applied, in which a fluid (typically water, although pressurized gas may also be used) is introduced into the metal blank enclosure and kept inside during the molding step. This fluid provides mechanical support to the walls of the metal blank to prevent deformation or collapse during the molding process. In such a case, prior to filling the container with the desired gas (i.e. prior to either step 308 or 310, see below), the fluid is removed from the enclosure at 307 and the enclosure is optionally cleaned and/or dried. Then at 308, the fastening ring 138 is fitted over the top of the molded layer with the upper part resting on adapter shoulders 134 to thereby obtain a container blank 200 (shown in FIG. 3B). In subsequent step 310 pressurized gas is introduced into the container's enclosure represented by arrow 312. This may be achieved in a pressure chamber or by coupling the upper part of the container blank to a pressurized gas outlet. Alternatively, filling of the container with pressurized gas may be carried out through the introduction of liquefied or solidified gas, such as solid carbon dioxide (known also as dry ice), which once heating to ambient temperature turns into gas. Then, at the next step 314, plug 136 is introduced into the seat of adapter 112 and the upper lips of the adapter are crimped (at step 316) to fit the plug in position, thereby obtaining a pressurized gas container of the kind described herein.

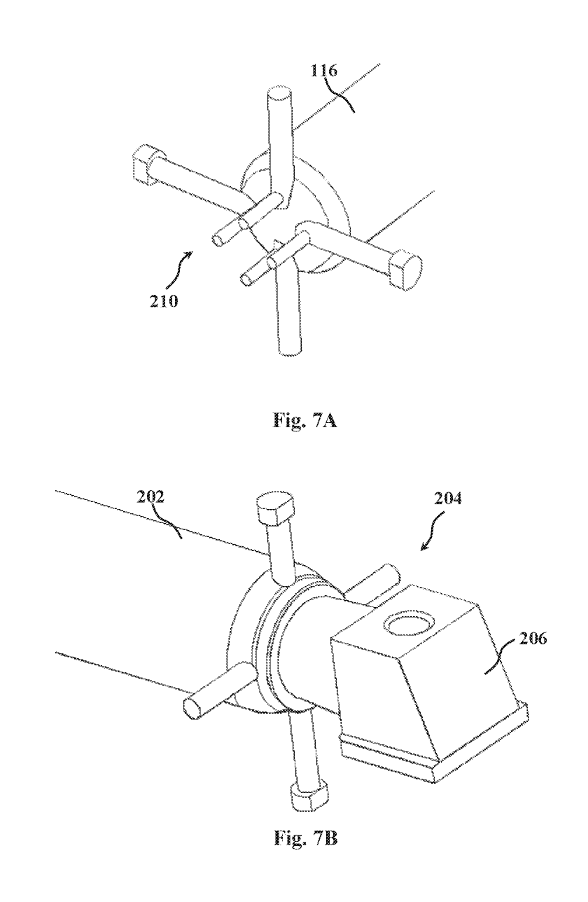

Reference is now made to FIGS. 7A and 7B which show an exemplary embodiment for molding of the molded layer over the metal blank. A metal blank 116, the bottom part of which is seen in FIG. 7A, is fitted into a mold 202 associated with a molding assembly generally designated 204 that is linked to a polymer melt feeding unit 206. Coupling assembly 210, shown in isolation in FIG. 7A for convenience of illustration, serves to centralize the blank within the mold and mechanically support it during the molding process. It is of note that although such coupling assembly is shown in FIGS. 7A-7B in association with the bottom of the metal blank, alternatively, the coupling assembly may be associated with the top portion of the metal blank, or even from both the bottom and top portions.

The polymer melt is then introduced into the space between the mold and the metal blank, that once cooled forms the molded layer. After the molded layer is obtained, the molding assembly 204 is disengaged from mold 202 and the multilayered container is extracted from the mold. The bores left at the bottom of the molded layer after coupling assembly 210 is removed are then filled with polymer melt and left to solidify, thus obtaining a complete molded layer.

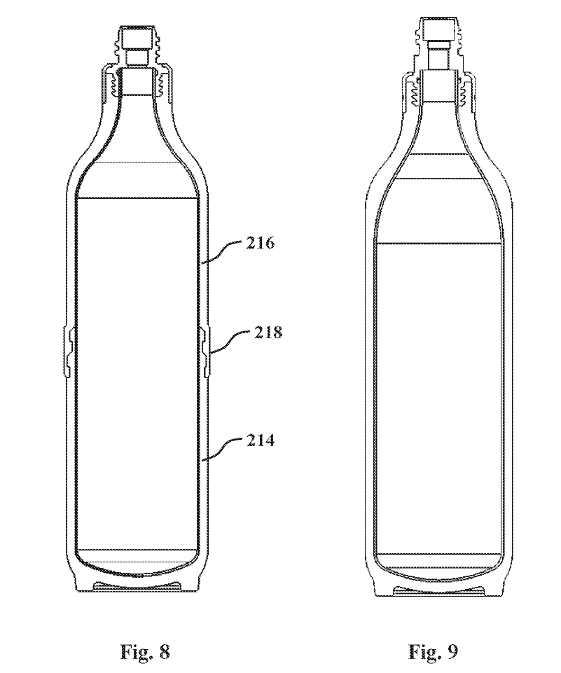

Two further exemplary multilayer containers formed without reinforcing elements, such as elements 122 and 124 shown in FIG. 1, are seen in FIGS. 8 and 9. In the multilayer container of FIG. 9 the molded layer is typically produced in a single molding step, while in that shown in FIG. 8 the molded layer is formed in a two-step process including first forming the bottom portion 214 of the molded layer and then the top portion 216, and typically as shown, is coupling portion 218 for tight association of the two portions.

1.-31. (canceled)

32. A pressurized gas container comprising:
a container body, defining a pressurized gas enclosure and a neck integral therewith extending from the shoulders of the container to an end portion that is configured for association with a gas port of a device and is fitted with a plug unit;
the container body has a multi-layer wall comprising a metal layer overlaid by a molded layer; and
the plug unit having
an axial bore dimensioned to accommodate a gas-channeling shaft of said gas port,
a generally planar barrier element at an inner end of the bore forming a gas-tight barrier between the bore and the enclosure, the barrier element having one or more first portions of reduced thickness to that of other portions of the barrier element such that upon exertion of force on the barrier the one or more first portions irreversibly rupture, and having
one or more sealing elements disposed in the bore and being distinct from said barrier element and configured for forming a gas-tight association with said shaft.

33. The container of claim 32, wherein
the pressurized gas within the container is pressurized carbon dioxide, and
is intended for association with a device, appliance or system for preparing and dispensing of a carbonated beverage.

34. The container of claim 32, wherein said barrier element is a metal sheet.

35. The container of claim 32, wherein said first portions are intersecting grooves, and wherein the barrier element is a disc and the groove intersect on the axis.

36. The container of claim 32, wherein the plug is fitted within an adapter which is coupled to the container's neck, the adapter comprises
a device-coupling portion and a container-coupling portion integral with one another;
the device-coupling portion comprises upright, axially extending first walls formed around a first lumen portion that defines a plug seat and having a threaded external face;
the container-coupling portion comprise downright, axially extending second walls tightly associated with and enveloping the upper portion of the neck's metal layer.

37. The container of claim 36, wherein (i) the second walls are embedded in or associated with the molded layer and has an external surface relief to permit tight association with the molder layer, and/or (ii) the second walls have an internal annular groove accommodating an O-ring for gas-tight association with the external surface of the internal metal layer of the neck.

38. The container of claim 32, wherein said internal layer is made of aluminum or aluminum alloy and/or the molded layer is made of a thermoplastic material.

39. The container of claim 32, comprising one or both of a bottom reinforcing element and a top reinforcing element that are coupled to or embedded in the molded layer.

40. The container of claim 32, wherein the ratio between the thickness of the molded layer to that of the metal layer being in the range of about 1:1 to 20:1.

41. A multipack comprising
a holder rack;
a carrying element; and
a plurality of pressurized gas containers of claim 32.

42. A process for the manufacture of a gas container, comprising:
molding a molded layer onto external surface of a metal blank of the container, the metal blank comprising a body defining an enclosure and a metal blank neck integral therewith extending from the shoulders of the metal blank, to thereby obtain a multi-layer container body with a neck portion configured for association with a gas port of a device;
fitting a plug unit into the neck to seal the neck in a gas-tight manner; the plug having an axial bore dimensioned to accommodate a gas-channeling shaft of said gas port, a generally planar barrier element disposed at an inner end of the bore and forming a gas-tight barrier, the barrier element having one or more first portions of reduced thickness to that of other portions of the barrier element such that upon exertion of force on the barrier the one or more first portions irreversibly rupture, and having one or more sealing elements disposed in the bore and being distinct from said barrier element and configured for forming a gas-tight association with said shaft; and prior to said fitting filling the container with pressurized gas.

43. The process of claim 42, wherein prior to said molding, filling the enclosure with a fluid, such as water or pressurized gas; and wherein prior to said filling emptying the fluid from the enclosure and optionally cleaning and/or drying the enclosure.

44. The process of claim 42, wherein the pressurized gas is carbon dioxide.

45. The process of claim 42, wherein said fitting comprises:
seating the plug within a seat formed in a first lumen portion of an adapter,
the adapter comprises a device-coupling portion and a container-coupling portion integral with one another,
the device coupling portion comprising upright, axially extending first walls defining the first lumen portion at and having a threaded extemal face,
the container-coupling portion comprise downright, axially extending second walls formed around a second lumen portion of a diameter so as to fit snugly over the internal metal layer of the neck; and
before or after said seating placing the adapter onto the blank neck such that said second walls tightly envelope the blank neck's upper portion.

46. The process of claim 45, comprising molding the molded layer such that a portion thereof overlays the second walls of the adapter.

47. The process of claim 45, comprising
fitting an O-ring within an internal annular groove formed in the second wall to thereby form a gas-tight association with the external surface of the internal metal layer of the neck.

48. The process of claim 45, comprising pressure fitting a fastening ring onto the container's neck and over the adapter.

49. The process of claim 42, wherein the molding is performed by cast molding or injection molding of a thermoplastic material.

50. The process of claim 42, comprising before molding fitting one or both of a bottom reinforcing element and a top reinforcing element at the bottom and onto shoulder of the container blank, respectively.

51. The process of claim 42, comprising molding the molded layer such that the ratio between the thickness of the molded layer to that of the metal blank being in the range of about 1:1 to 20:1.
